(19) United States
(12) Patent Application Publication
(10) Pub. No.: US 2014/0310012 A1
(43) Pub. Date: Oct. 16, 2014

(54) CENTRALIZING PROTOCOL GUIDANCE AND DOCUMENTATION FOR A HEALTHCARE EVENT

(71) Applicant: CERNER INNOVATION, INC., Lenexa, KS (US)

(72) Inventor: FRANK A. AZZARO, Olathe, KS (US)

(73) Assignee: CERNER INNOVATION, INC., Lenexa, KS (US)

(21) Appl. No.: 13/861,045

(22) Filed: Apr. 11, 2013

(51) Int. Cl. G06F 19/00

(52) U.S. Cl. CPC G06F 19/325
USPC 705/2

(57) ABSTRACT

Systems, methods, computer-readable media, and graphical user interfaces for centralizing protocol guidance and documentation for a healthcare event are provided. In embodiments, protocols corresponding to healthcare events are received. Upon determining a particular healthcare event has occurred for a patient, a clinician is prompted to perform an action in accordance with the protocol. Information associated with the patient is received and, based on the information, a next action is selected. The clinician is prompted to perform the next action. In embodiments, an inventory of items used for the protocol is maintained and compared against a stock of items to determine when the stock of items needs to be restocked.

### BACKGROUND

Protocols for particular healthcare events are often provided to healthcare providers by third parties. The protocols are typically flow charts indicating best practice methods for treating a patient associated with the particular healthcare event. In some instances, the protocols are frequently updated making it difficult for the healthcare provider or clinician to follow the most up-to-date protocol for the patient. In code blue or trauma related events, clinicians are often moving at a frenetic pace to treat the patient. The initiation of a code blue event, for example, may require a clinician to hit a button on the wall to start the code blue protocol. A nurse manage may have a clipboard, another clinician may be required to watch a clock to facilitate timing certain items required by the protocol, another clinician may be frantically asking questions (e.g., when was the patient given a particular drug or treatment), and yet another clinician may be constantly folding up electrocardiogram (EKG) strips to put in an electronic medical record (EMR) associated with the patient. As can be appreciated, many opportunities for error exist.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to methods, systems, and computer readable media for centralizing protocol guidance and documentation for a healthcare event. More particularly, algorithms associated with a particular protocol are automated to guide a clinician or clinicians in responding to and documenting a healthcare event associated with a patient.

Accordingly, in one embodiment, computer storage media having computer-executable instructions embodied thereon that, when executed by a processor, cause the processor to perform a method of centralizing protocol guidance and documentation for a healthcare event. The method comprises: receiving a protocol corresponding to a healthcare event; determining the healthcare event has occurred for a patient; prompting a clinician to perform an action in accordance with the protocol; receiving information associated with the patient; based on the information, selecting a next action; and prompting the clinician to perform the next action.

In another embodiment, a computer system, comprising a processor coupled to a computer storage medium, the computer storage medium having stored thereon a plurality of computer software components executable by the processor, centralizes protocol guidance and documentation for a healthcare event is provided. The computer system comprises: a protocol component for receiving a protocol corresponding to a healthcare event; a determining component for determining the health care event has occurred for the patient; a prompting component for prompting a clinician to perform an action in accordance with the protocol; a receiving component for receiving information associated with the patient; and an inventory component for maintaining an inventory of items used for the protocol.

In another embodiment, computer storage media having computer-executable instructions embodied thereon that, when executed by a processor, cause the processor to produce a graphical user interface (GUI) that facilitates centralizing protocol guidance and documentation for a healthcare event. The GUI comprises: a patient display area for displaying information associated with a patient; a prompt display area for displaying one or more prompts to a clinician, the one or more prompts guiding the clinician through actions in accordance with a protocol selected based on an event associated with the patient; an event display area for displaying the event associated with the patient; a medications display area that displays items used during the protocol and alerts personnel to restock the items when the inventory is low; an actions display area that displays actions performed during the protocol; and a personnel display area that displays clinicians involved in the protocol.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is an exemplary system architecture suitable for use in implementing embodiments of the present invention;

FIG. 3 is a flow diagram of a method in accordance with an embodiment of the present invention; and

FIGS. 4-6 are illustrative screen displays in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention automate algorithms associated with a protocol for a particular healthcare event to guide a clinician or clinicians in responding to and documenting the healthcare event associated with a patient. Embodiments of the present invention further allow for automated updates to the protocol to keep a healthcare facility up-to-date with the most recently approved third party provided treatment guidelines. Embodiments of the present invention automate documentation for the healthcare event. Embodiments of the present invention maintain an inventory of items required, used, and needed for the particular healthcare event so the healthcare facility is able to restock items at the appropriate time.

Having briefly described embodiments of the present invention, an exemplary operating environment suitable for use in implementing embodiments of the present invention is described below.

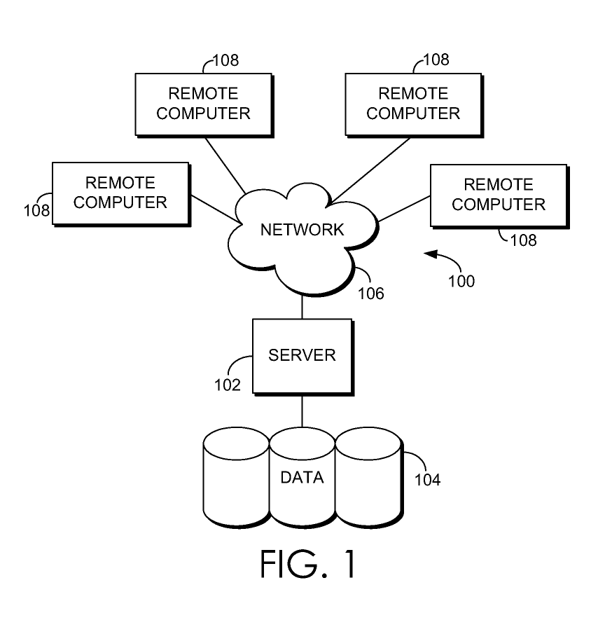

Referring to the drawings in general, and initially to FIG. 1 in particular, an exemplary computing system environment, a medical information computing system environment, with which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary medical information computing system environment 100 includes a general purpose computing device in the form of a control server 102. Components of the control server 102 may include, without limitation, a processing unit, internal system memory, and a suitable system bus for coupling various system components, including database cluster 104, with the control server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 102. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the control server 102. The control server 102 may operate in a computer network 106 using logical connections to one or more remote computers 108. Remote computers 108 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as intensivists, surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the elements described above in relation to the control server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the control server 102 may include a modem or other means for establishing communications over the WAN, such as the Internet. In a networked environment, program modules or portions thereof may be stored in association with the control server 102, the database cluster 104, or any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) may be utilized.

In operation, a clinician may enter commands and information into the control server 102 or convey the commands and information to the control server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 102. In addition to a monitor, the control server 102 and/or remote computers 108 may include other peripheral output devices, such as speakers and a printer.

Although many other internal components of the control server 102 and the remote computers 108 are not shown, those of ordinary skill in the art will appreciate that such components and their interconnection are well known. Accordingly, additional details concerning the internal construction of the control server 12 and the remote computers 18 are not further disclosed herein.

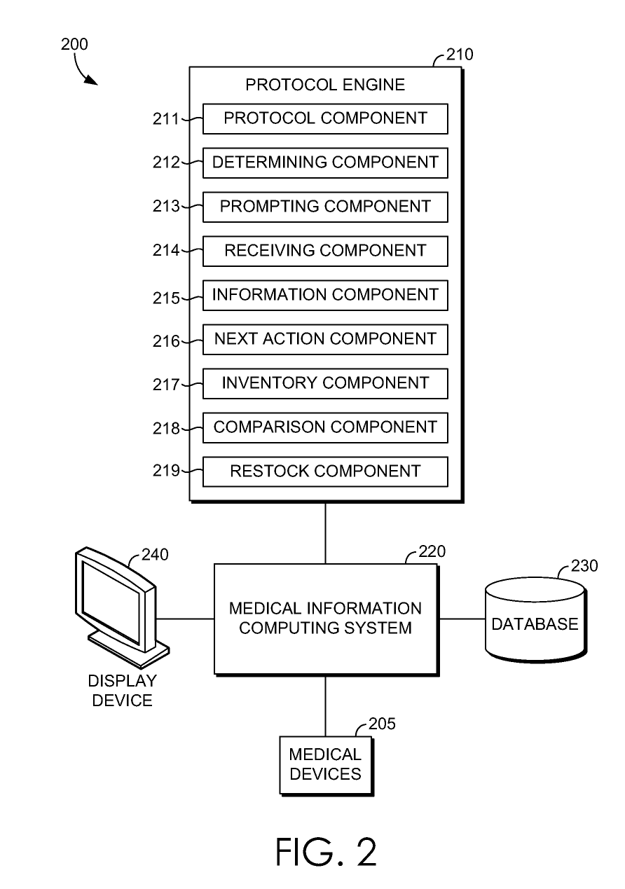

With reference to FIG. 2, a block diagram is illustrated that shows an exemplary computing system architecture 200 for centralizing protocol guidance and documentation for a healthcare event. It will be appreciated that the computing system architecture shown in FIG. 2 is merely an example of one suitable computing system and is not intended as having any dependency or requirement related to any single module/component or combination of modules/components.

The computing system architecture 200 includes one or more medical devices 205, protocol engine 210, medical information computing system 220, database 230, and display device 240. Data elements are received from medical devices 205. A medical device 205 may be any device, stationary or otherwise, that may be used to treat, diagnose, monitor, or measure aspects of a patient in a hospital, doctor's office, etc. For exemplary purposes only and not limitation, medical devices include cardiac monitors, cardiac output monitors, ICP monitors, ventilators, pumps (e.g., infusion pumps, balloon pumps), and the like. As such, these medical devices generate various data (e.g., heart-rate changes) that is communicated to database 230 via medical information computing system 220.

Database 230 contains a variety of information data for the patient in a patient's electronic medical record (EMR) as well as staff information (i.e., names, numbers, and tracking data) associated with a unit and alert information associated with the patients. As utilized herein, the acronym “EMR” is not meant to be limiting, and may broadly refer to any or all aspects of the patient's medical record rendered in a digital format. Generally, the EMR is supported by systems configured to co-ordinate the storage and retrieval of individual records with the aid of computing devices. As such, a variety of types of healthcare-related information may be stored and accessed in this way. By way of example, the EMR may store one or more of the following types of information: patient demographic; medical history (e.g., examination and progress reports of health and illnesses); medicine and allergy lists/immunization status; laboratory test results, radiology images (e.g., X-rays, CTs, MRIs, etc.); evidence-based recommendations for specific medical conditions; a record of appointments and physician's notes; billing records; and data received from an associated medical device. Accordingly, systems that employ EMRs reduce medical errors, increase physician efficiency, and reduce costs, as well as promote standardization of healthcare. Display device 240 may be a workstation on wheels, a touchscreen device, a handheld computing device, a dashboard, a computer screen, or any other hardware device used for displaying output and capable of displaying graphical user interfaces.

Protocol engine 210 receives and displays data from medical information computing system 220, database 230 and/or one or more medical devices 205 on the display device 240. Protocol engine 210 may reside on one or more computing devices, such as, for example, the control server 102 described above with reference to FIG. 1. By way of example, the control server 102 includes a computer processor and may be a server, personal computer, desktop computer, laptop computer, handheld device, mobile device, consumer electronic device, or the like. Protocol engine 210 comprises, in various embodiments, protocol component 211, determining component 212, prompting component 213, receiving component 214, information component 215, next action component 216, inventory component 217, comparison component 218, and restock component 219.

Protocol component 211 receives a protocol corresponding to a healthcare event. In one embodiment, the protocol component is further configured for receiving updates to the protocol and communicating the updates to prompting component 213. The protocol may be received from a third party that provides workflows for treating patients for the particular healthcare event according to best practices as determined by the third party. In one embodiment, the protocol is a trauma protocol. In one embodiment, the protocol is a code blue protocol. In one embodiment, the code blue protocol is received from the American Heart Association. In one embodiment, the protocol is dynamically updated in accordance with the updates received from the third party (e.g., the American Heart Association). For example, the American Heart Association may periodically update the protocol. When the protocol is updated, the American Heart Association may provide the updates to the healthcare facility (i.e., the protocol component 211). Upon receipt of the updates, the protocol component communicates the updates to prompting component 213, allowing the healthcare facility to implement the updated protocol for any future healthcare events.

Determining component 212 determines the health care event has occurred for the patient. The determination may be based on a diagnosis of the patient. The determination may be based on information received by receiving component 214, such as information received from one or more medical devices 205 or an EMR associated with the patient. The determination does not require manual action taken by a clinician, such as pushing a code button on a wall or computing device.

Prompting component 213 prompts a clinician to perform an action in accordance with the protocol. In a code blue scenario for adult cardiac arrest, a protocol provided by the American Heart Association may be utilized. The clinician may be initially prompted to shout for help and/or activate an emergency response. The clinician may also be prompted to begin cardiopulmonary resuscitation (CPR), give oxygen to the patient, and/or attach a monitor or defibrillator to the patient. The prompts may be clinician specific and based on a proximity, role, or location of the clinician or the display device 240 associated with that particular clinician.

Receiving component 214 receives information associated with the patient. The information may indicate whether a heart rhythm associated with the patient is appropriate for shocking the patient. The information may indicate whether an appropriate or minimum amount of time has elapsed since the patient was administered a medication or treatment. The information may further be information that is charted in the EMR associated with the patient.

In one embodiment, information component 215 selects a next action based on the information. Based on the information, the next action is selected. For example, if the patient is shockable, the information component 215 may select to shock the patient as the next action. Similarly, if the patient is to be administered a particular medication or treatment every three minutes, and three minutes has elapsed, the information component 215 may select to administer that medication or treatment. Once selected, in one embodiment, next action component 216 prompts the clinician to perform the next action.

Inventory component 217 maintains an inventory of items used for the protocol. The protocol may require that certain medications or treatments are administered to the patient. Inventory component 217 keeps tracks items actually used during a particular healthcare event. In one embodiment, comparison component 218 compares the inventory of items against a stock of items. In one embodiment, restock component 219 determines when the stock of items needs to be restocked. This allows the healthcare facility to determine, at step 326, in one embodiment, when the stock of items needs to be restocked, such as when the stock of items decreases below a minimum allowable threshold necessary for performing the protocol on a certain number of patients.

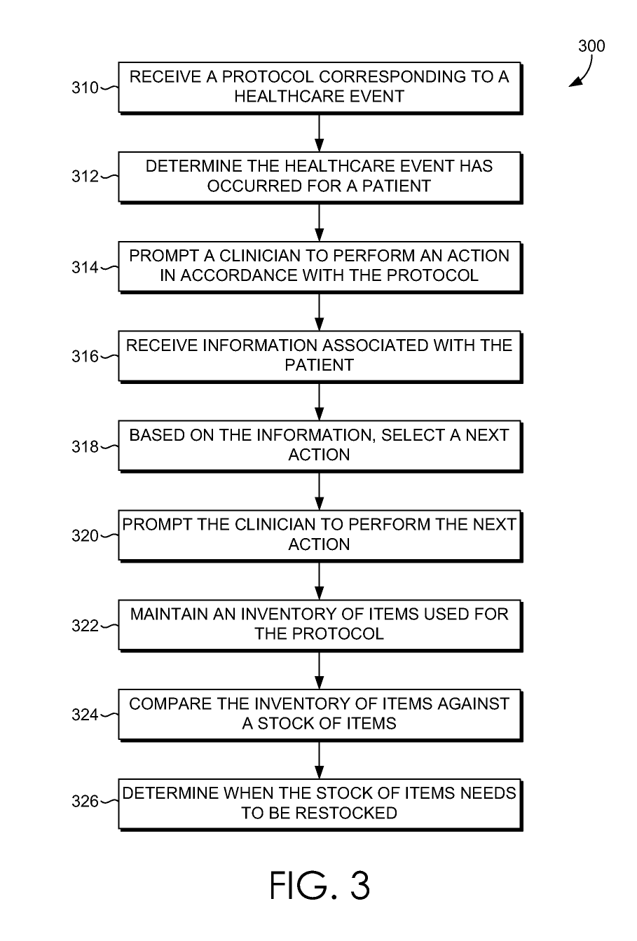

Referring now to FIG. 3, an illustrative flow diagram 300 is shown of a method in accordance with embodiments of the present invention. At step 310, a protocol corresponding to a healthcare event is received. In one embodiment, the protocol is a trauma protocol. In one embodiment, the protocol is a code blue protocol. In one embodiment, the code blue protocol is received from the American Heart Association. In one embodiment, the code blue protocol is dynamically updated upon receiving an indication from the American Heart Association. For example, the American Heart Association may periodically update the protocol. When the protocol is updated, the American Heart Association may provide an indication that the protocol has been updated. Upon receipt of this indication, the updated protocol may be received by the healthcare facility, allow the healthcare facility to implement the updated protocol for any future healthcare events.

It is determined, at step 312, the healthcare event has occurred for a patient. A clinician is prompted to perform an action in accordance with the protocol at step 314. At step 316, information associated with the patient is received. In one embodiment, the information is received from on e or more medical devices associated with the patient. In one embodiment, the information is documented in an EMR associated with the patient. Based on the information, a next action is selected at step 318. The clinician is prompted, at step 320, to perform the next action. In one embodiment, time associated between actions of the protocol is monitored. For example, the protocol may prompt the clinician to administer a particular medication or treatment every three minutes. The time is monitored so the clinician is prompted each time the medication or treatment should be administered again. In one embodiment, an indication to pause the protocol is received. This allows the clinician to document additional information or perform a different action.

In one embodiment, at step 322, an inventory of items used for the protocol is maintained. For example, the protocol may require that certain medications or treatments are administered to the patient. Thus, the inventory of items actually used is maintained. In one embodiment, at step 324, the inventory of items actually used is compared against a stock of items. This allows the healthcare facility to determine, at step 326, in one embodiment, when the stock of items needs to be restocked, such as when the stock of items decreases below a minimum allowable threshold necessary for performing the protocol on a certain number of patients. This may be based on an expected number of patients that will require the protocol, or an aggregation of an expected number of patients requiring that particular item for any number of protocols.

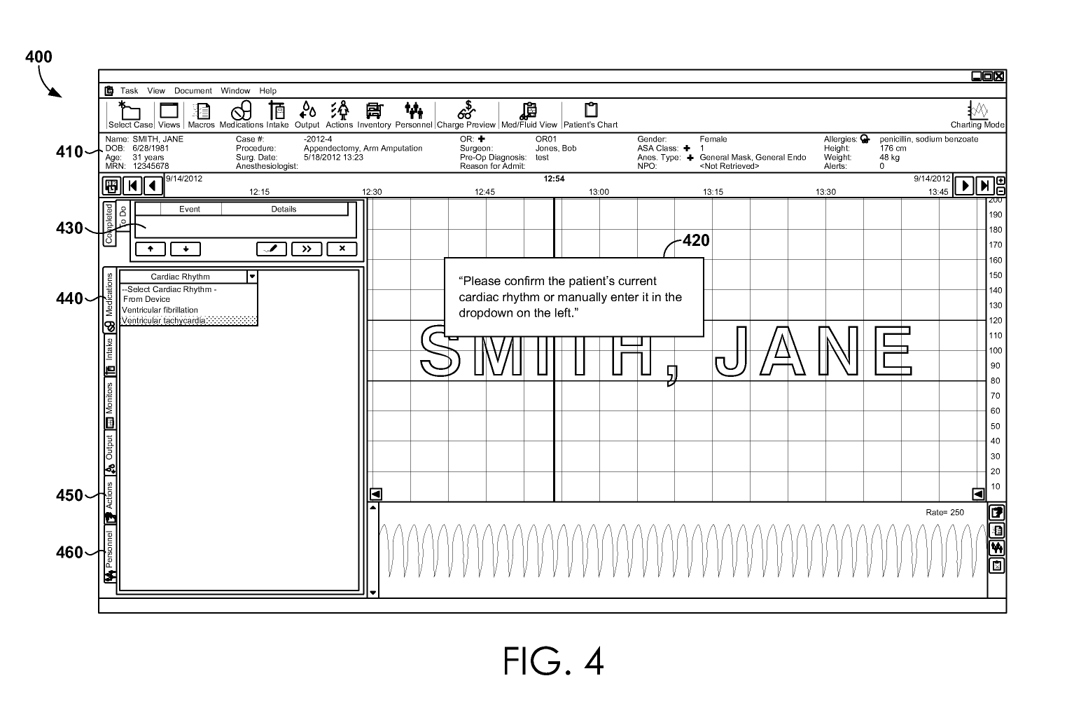

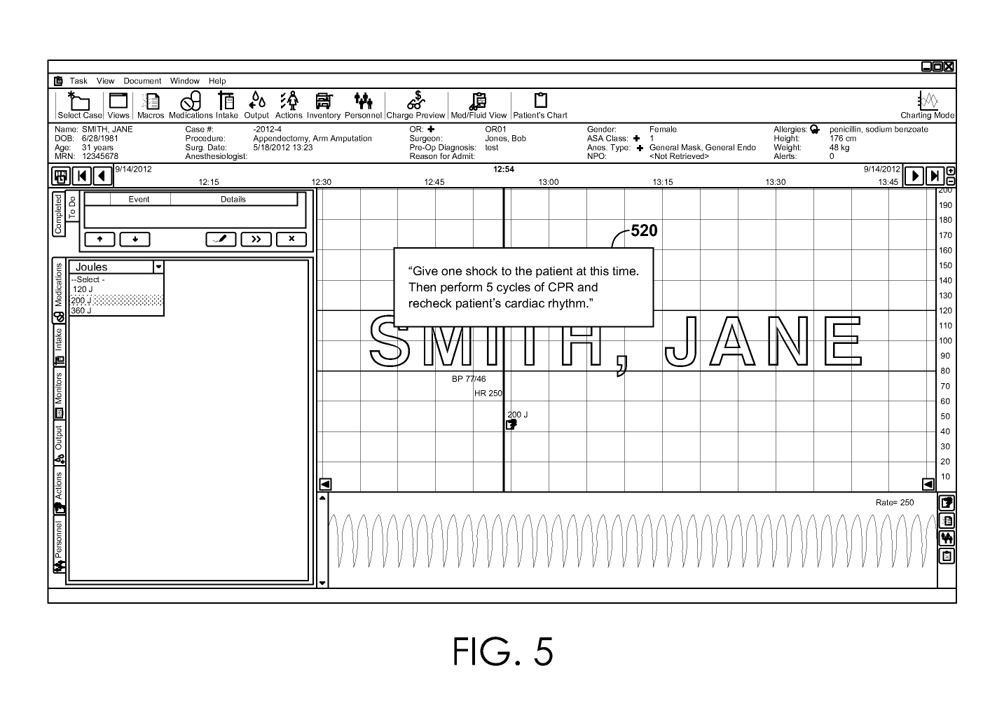

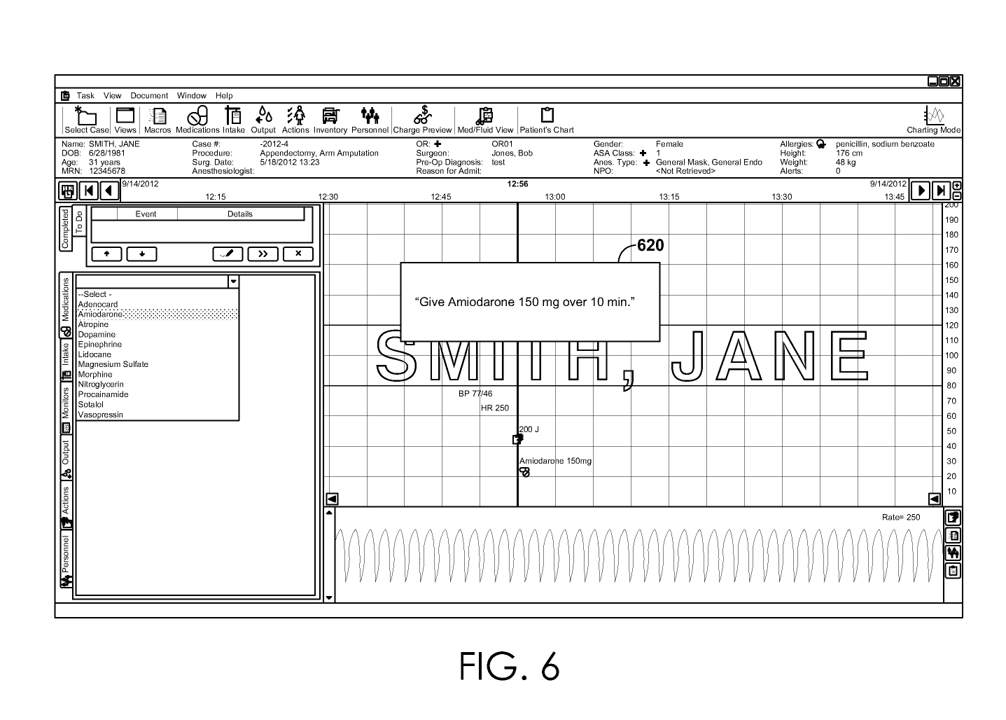

Referring now to FIGS. 4-6, illustrative screen display 400 illustrates a GUI that facilitates centralizing protocol guidance and documentation for a healthcare event, in accordance with an embodiment of the present invention. A patient display area 410 displays information associated with a patient. The information may include a name, a date of birth, n age, date, internal healthcare facility reference numbers, procedure, clinician(s), location, diagnosis, reason for admission, gender, allergies, height, weight, and the like.

Prompt display areas 420, 520, 620 display one or more prompts to a clinician. The one or more prompts guide the clinician or clinicians through actions in accordance with a protocol selected based on an event associated with the patient. As noted previously, the event may necessitate a particular protocol which may be received from a third party and include directions for treating a patient associated with the event. The protocol may prompt a clinician to confirm a particular measurement associated with a patient as measured by one or more medical devices. The protocol may prompt the clinician to perform an action on the patient, such as performing CPR or shocking the patient. The protocol may prompt the clinician to administer a medication or treatment to the patient, such as administering oxygen or epinephrine, attaching a monitor or defibrillator, and the like. Based on information received or a first action taken in response to a prompt, another prompt may be presented or displayed to the clinician.

An event display area 430 displays the event associated with the patient. Details associated with the event may also be displayed in event display area 430. For example, the event display area 430 may display that the patient is in cardiac arrest. The details may indicate the protocol being used to treat the patient or identify the source of the protocol. The details may further indicate a step in the protocol currently being administered or provided to the patient.

A medications display area 440 displays medications or items used during the protocol. This assists personnel charged with restocking low inventory items by alerting the personnel to restock the items when the inventory is low due to items being used or accounted for in an ongoing protocol.

An actions display area 450 displays actions performed during the healthcare event and in accordance with the protocol. These actions may alert various personnel that another clinician is performing a particular action. The actions may also assist a clinician for documentation purposes. Further, the actions may assist the healthcare facility for reporting or reimbursement purposes by affirmatively document each action taken during the healthcare event to reinforce documentation that the protocol was followed in accordance with the requisite procedures.

A personnel display area 460 displays clinicians involved in the protocol. The personnel may be selected based on a role, proximity, or location. Further, the presence of the personnel may be detected, causing the personnel to be automatically displayed in the personnel display area 460. The personnel display area 460 may also be utilized for reporting, staffing, reimbursement purposes as well as to reinforce documentation that appropriate personnel were present during the healthcare event.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer storage media having computer-executable instructions embodied thereon, that when executed by a processor, causes the processor to perform a method of centralizing protocol guidance and documentation for a healthcare event, the method comprising:
receiving a protocol corresponding to a healthcare event;
determining the healthcare event has occurred for a patient;
prompting a clinician to perform an action in accordance with the protocol;
receiving information associated with the patient;
based on the information, selecting a next action; and
prompting the clinician to perform the next action.

2. The media of claim 1, further comprising maintaining an inventory of items used for the protocol.

3. The media of claim 2, further comprising comparing the inventory of items against a stock of items.

4. The media of claim 3, further comprising determining when the stock of items needs to be restocked.

5. The media of claim 1, wherein the protocol is a code blue protocol.

6. The media of claim 5, wherein the code blue protocol is received from the American Heart Association.

7. The media of claim 1, wherein the code blue protocol is dynamically updated upon receiving an indication from the American Heart Association.

8. The media of claim 1, wherein the protocol is a trauma protocol.

9. The media of claim 1, wherein the information is received from one or more medical devices associated with the patient.

10. The media of claim 1, further comprising documenting the information in an electronic medical record associated with the patient.

11. The media of claim 10, further comprising monitoring time associated between actions of the protocol.

12. The media of claim 10, further comprising receiving an indication to pause the protocol to document additional information or perform a different action.

13. A computer system that centralizes protocol guidance and documentation for a healthcare event, the computer system comprising a processor coupled to a computer storage medium, the computer storage medium having stored thereon a plurality of computer software components executable by the processor, the computer system comprising:
a protocol component for receiving a protocol corresponding to a healthcare event;
a determining component for determining the health care event has occurred for the patient;
a prompting component for prompting a clinician to perform an action in accordance with the protocol;
a receiving component for receiving information associated with the patient; and
an inventory component for maintaining an inventory of items used for the protocol.

14. The system of claim 13, further comprising a comparison component for comparing the inventory of items against a stock of items.

15. The system of claim 14, further comprising a restock component for determining when the stock of items needs to be restocked.

16. The system of claim 13, an information component for selecting a next action based on the information.

17. The system of claim 16, a next action component for prompting the clinician to perform the next action.

18. The system of claim 13, wherein the protocol component is further configured for receiving updates to the protocol and communicating the updates to the prompting component.

19. The system of claim 18, wherein the prompting component prompts the clinician to perform the action in accordance with the updated protocol.

20. Computer storage media having computer-executable instructions embodied thereon that, when executed by a processor, causes the processor to produce a graphical user interface (GUI) that facilitates centralizing protocol guidance and documentation for a healthcare event, the GUI comprising:
a patient display area for displaying information associated with a patient;
a prompt display area for displaying one or more prompts to a clinician, the one or more prompts guiding the clinician through actions in accordance with a protocol selected based on an event associated with the patient;
an event display area for displaying the event associated with the patient;
a medications display area that displays items used during the protocol and alerts personnel to restock the items when the inventory is low;
an actions display area that displays actions performed during the protocol; and
a personnel display area that displays clinicians involved in the protocol.
